(19) United States
(12) Patent Application Publication
(10) Pub. No.: US 2009/0132425 A1
(43) Pub. Date: May 21, 2009

(54) METHODS AND SYSTEMS FOR FINANCIAL TRANSACTION CARD SECURITY

(76) Inventors: Peter P. Hogan, O'Fallon, MO (US); Ryan Triplett, O'Fallon, MO (US)

Correspondence Address: DANIEL M. FITZGERALD (21652);ARMSTRONG TEASDALE LLP, ONE METROPOLITAN SQUARE, SUITE 2600, ST. LOUIS, MO, 63102-2740, US

(21) Appl. No.: 11/943,464

(22) Filed: Nov. 20, 2007

(51) Int. Cl. G06Q 30/00

(52) U.S. Cl. 705/76; 235/381; 235/493; 705/44

(57) ABSTRACT

A financial transaction card having a front side and a back side is provided and further includes a magnetic strip configured to retain data associated with a financial transaction card account, where the account is associated with the card, and a character grid printed on one of the front side and the back side. A method for securing transactions that are not made in person utilizing a financial transaction card are also provided.

### BACKGROUND OF THE INVENTION

This invention relates generally to methods and systems for payment card security, and more particularly to network-based systems and methods that utilize a security grid having access codes printed on a financial transaction card for reducing unauthorized transactions utilizing the card and affecting the associated account.

Financial transaction cards have made great gains in the United States and elsewhere as a means to attract financial accounts to financial institutions and, in the case of credit cards, as a medium to create small loans and generate interest income for financial institutions. Nonetheless, the financial transaction card industry is subject to certain well-known problems.

Taking the credit card industry, for example, it is well-known that at least some persons will engage in illegal or potentially illegal activities. Specifically, one person may steal a credit card from another person and attempt to use the credit card to purchase products, pay for services, or attempt to utilize the card to obtain cash. Such problems are not limited to credit cards. Other examples include debit cards, gift cards, stored value cards, and check cards. Of course, in certain transactions, for example, on-line and telephonic transactions, physical possession of the financial transaction card is not needed. Rather, only the numbers (e.g., account numbers and/or expiration date) associated with the financial transaction card are needed to complete a transaction. The fact that a physical financial transaction card is not needed for certain transactions only amplifies the problems mentioned herein.

The other parties involved in facilitating such transactions, namely the acquirer bank, the issuer bank, and the financial transaction card network, which is sometimes referred as an interchange, generally do not require the legal cardholder to pay for such fraudulent transactions. Such a requirement will likely result in the loss of good will and perhaps the loss of the legal cardholder as a customer. However, the fraudulent transactions then become a loss to one or more of these entities. Therefore, credit card networks and the other entities have a need for improving the likelihood that transactions, including transactions of the type that are not made in person, are being initiated by the legal cardholder.

Accordingly, methods and systems that help to ensure that the sales and other activities associated with a particular financial transaction card are being initiated by the proper user are needed. Such methods and systems would provide at least some confidence that the legal holder of the financial transaction card is the person attempting the transaction.

### BRIEF DESCRIPTION OF THE INVENTION

In one aspect, a financial transaction card having a front side and a back side is provided that further includes a magnetic strip configured to retain data associated with a financial transaction card account, the account associated with the card, and a character grid printed on one of the front side and the back side.

In another aspect, a method for securing transactions that are not made in person, utilizing a financial transaction card and an input device is provided in which the financial transaction card includes a two-dimensional character grid of character fields each having a character printed therein. The method includes entering, into the input device, a user identification and password that are associated with the financial transaction card, receiving a prompt that requests the cardholder to enter the characters associated with a number of character fields in the character grid printed on the financial transaction card, and entering the characters printed within the requested character fields into the input device.

In still another aspect, a network-based system for securing financial transaction card account transactions is provided where the transactions are initiated by customers over a financial transaction card network. The system includes a plurality of financial transaction cards, a client system comprising a browser, a database for storing information, and a server system configured to be coupled to the client system and the database. The plurality of financial transaction cards each include a character grid of character fields printed on at least one of a front side and a back side of the cards where the character fields each have an individual character printed therein. The server system is further configured to store within the database a plurality of the character grids, each character grid representative of a character grid printed on a respective one of the financial transaction cards. Upon receipt of a user identifier and password from a potential customer for a specific one of the financial transaction cards, the server is also configured to cause the client system to prompt the potential customer to enter the characters associated with a number of specific character grid locations as printed on the specific financial transaction card. Upon receipt of characters from the client system, the server system is configured to compare the received characters to determine if they match the corresponding characters for the individual financial transaction card stored within the database.

### BRIEF DESCRIPTION OF THE DRAWINGS

FIG. 1 is a flowchart illustrating a typical financial transaction using a financial transaction card payment system.

FIG. 2 is a simplified block diagram of an exemplary embodiment of a server architecture of a system in accordance with one embodiment of the present invention.

FIG. 3 is an expanded block diagram of an exemplary embodiment of a server architecture of a system in accordance with one embodiment of the present invention.

FIG. 4 is an illustration of a financial transaction card that incorporates a character card printed thereon.

FIG. 5 is a flowchart illustrating exemplary processes utilized by the system shown in FIG. 2 in conjunction with the character grid illustrated in FIG. 4.

### DETAILED DESCRIPTION OF THE INVENTION

Described in detail herein are exemplary embodiments of systems and processes that help to ensure that the sales and other activities associated with a particular financial transaction card are being initiated by the proper user, especially for those transaction that are not made in person. Such methods and systems would provide at least some confidence that the legal holder of the financial transaction card is the person attempting the transaction. As will be further explained herein, with so many financial transaction card purchases being conducted, for example, over the Internet, telephone, and via other not-in-person methods, it has become increasingly difficult to ensure that the proper cardholder is conducting the transaction, or even in possession of the physical embodiment of the financial transaction card. Once it is determined that a person attempting a transaction does not appear to be in physical possession of the financial transaction card using the systems and processes described herein, the entity operating the financial transaction card network or interchange (e.g., MasterCard®) would then work to prevent the transaction from occurring (MasterCard is a registered trademark of MasterCard International Incorporated located in Purchase, N.Y.).

The systems and processes facilitate, for example, electronic submission of information printed on the physical embodiment of the financial transaction card using a client system, automated extraction of information associated with the physical embodiment of the financial transaction card, and web-based reporting for internal and external system users. A technical effect of the systems and processes described herein include at least one of (a) providing a financial transaction card with a character grid printed thereon as described below, (b) storing a character grid that is associated with a particular physical embodiment of the financial transaction card within the financial transaction card network or interchange, and (c) utilizing the grid as a portion of a two factor authentication, or security, process for transactions not made in person by requiring the purchaser to enter random data associated with the character grid that is printed on the physical embodiment of the financial transaction card.

In one embodiment, a physical embodiment of the financial transaction card is provided having a character grid printed thereon. In another embodiment, a client user interface front-end for administration and a web interface for user input is provided. In an exemplary embodiment, the system is web enabled and is accessible via the Internet. In a further exemplary embodiment, the system is being run in a Windows® environment (Windows is a registered trademark of Microsoft Corporation, Redmond, Wash.). The methods are flexible and capable of being run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

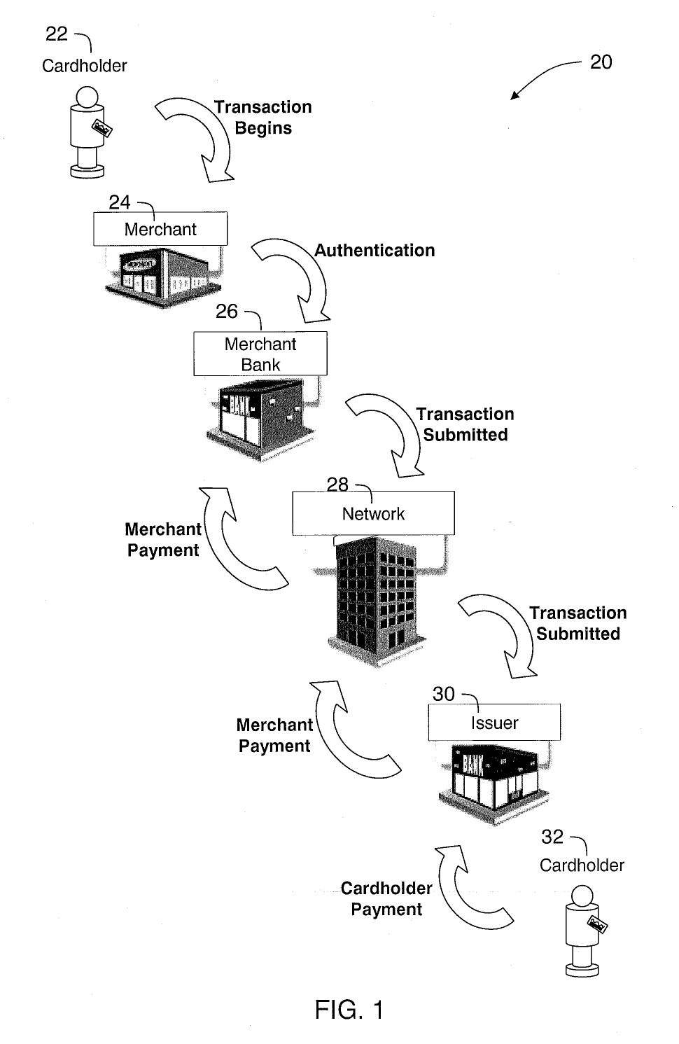

FIG. 1 is a flowchart 20 illustrating a typical financial transaction using a financial transaction card payment system. The present invention is related to a financial transaction card payment system, such as a credit card payment system using the MasterCard® interchange. The MasterCard® interchange is a proprietary communications standard promulgated by MasterCard International Incorporated® for the exchange of financial transaction data between financial institutions that are members of MasterCard International Incorporated®.

In a typical financial payment system, a financial institution called the “issuer” issues a financial transaction card, such as a credit card, to a consumer, who uses the financial transaction card to tender payment for a purchase from a merchant. To accept payment with the financial transaction card, the merchant must normally establish an account with a financial institution that is part of the financial payment system. This financial institution is usually called the “merchant bank” or the “acquiring bank” or “acquirer bank.” When a consumer 22 tenders payment for a purchase with a financial transaction card, the merchant 24 requests authorization from the merchant bank 26 for the amount of the purchase. The request may be performed over the telephone, but is usually performed through the use of a point-of-sale terminal, which reads the consumer's account information from the magnetic stripe on the financial transaction card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor.”

Using the interchange 28, the computers of the merchant bank or the merchant processor will communicate with the computers of the issuer bank 30 to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account 32 is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which are settled as a group.

Financial transaction cards or payment cards can refer to credit cards, debit cards, and various types of prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs. While generally described as related to a purchasing transaction, it should be understood that the descriptions are applicable to bill payment, reward redemption, and checking of statements.

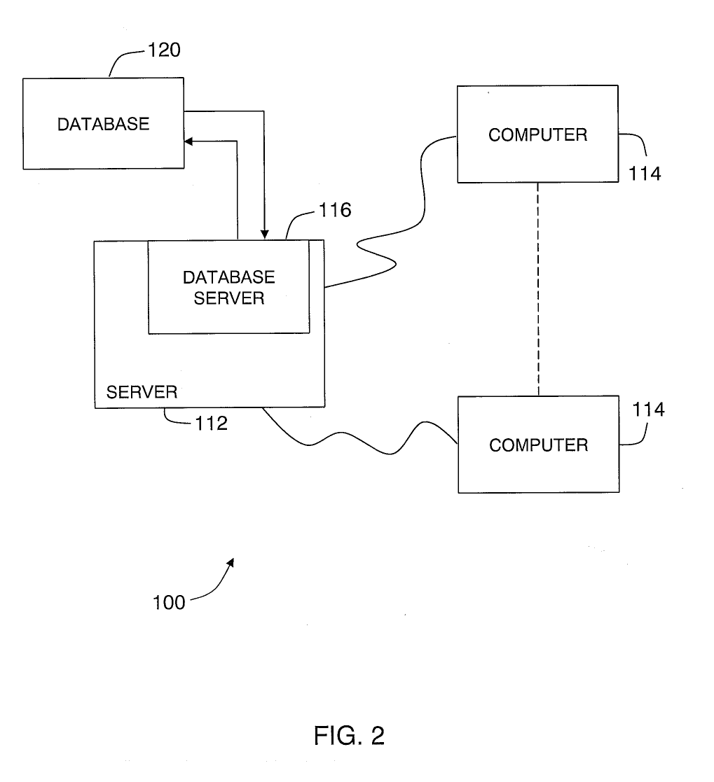

FIG. 2 is a simplified block diagram of an exemplary system 100 in accordance with one embodiment of the present invention. In one embodiment, system 100 is the financial transaction card payment system shown in FIG. 1, which can be utilized for ensuring a person or entity attempting to utilize a financial transaction card is in possession of the physical embodiment of the financial transaction card. More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any device capable of interconnecting to the Internet including a web-based phone, personal digital assistant (PDA), or other web-based connectable equipment. A database server 116 is connected to a database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

As discussed below, character grids that are associated with physical embodiments of individual financial transaction cards are stored within database 120.

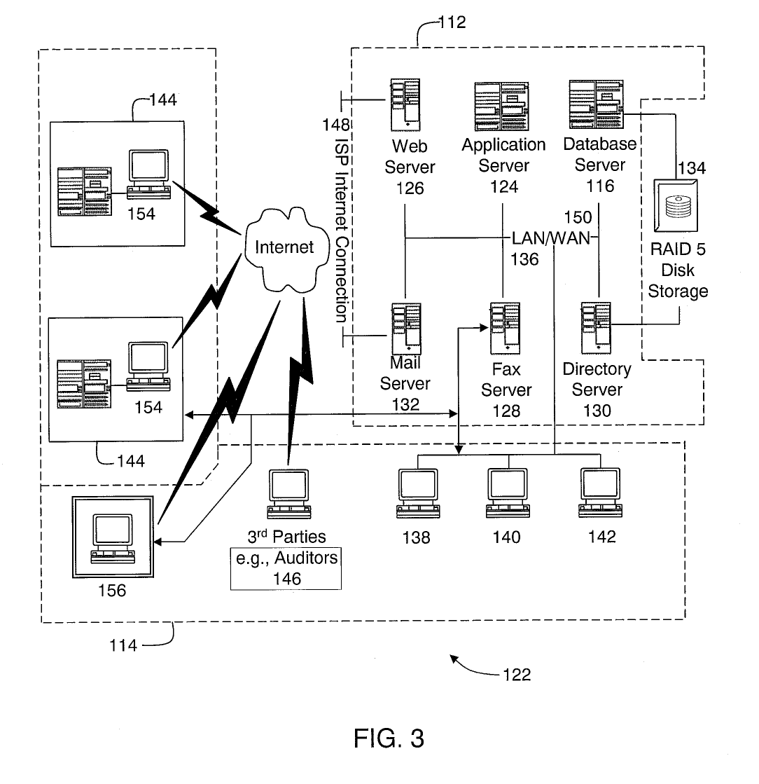

FIG. 3 is an expanded block diagram of an exemplary embodiment of a server architecture of a system 122 in accordance with one embodiment of the present invention. Components in system 122, identical to components of system 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., auditors, 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

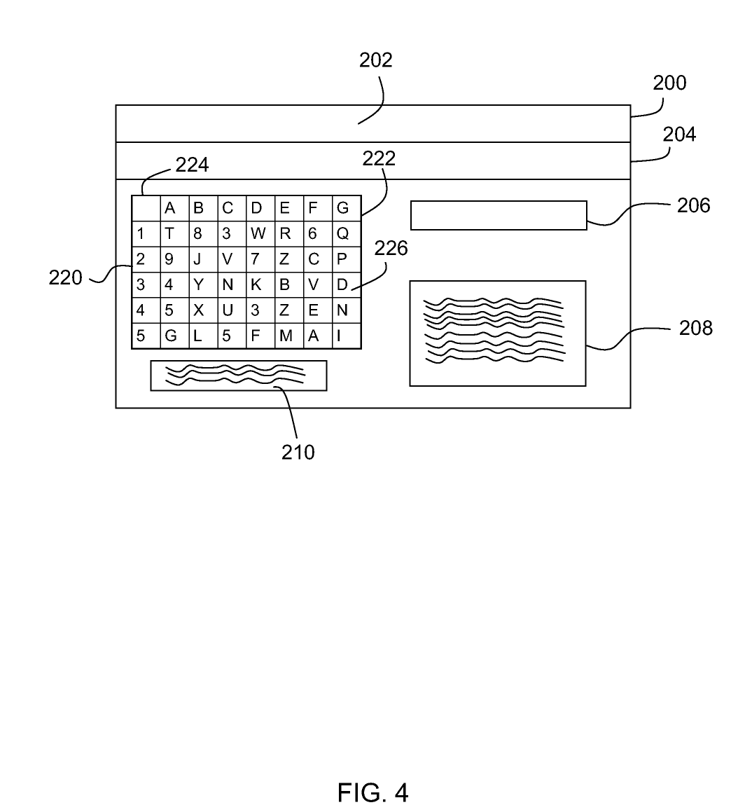

FIG. 4 is an illustration of a financial transaction card 200, more specifically a back side 202 of the physical embodiment of the financial transaction card 200. As illustrated, the back side 202 includes a magnetic strip 204 configured to retain data associated with an account associated with the financial transaction card 200. The financial transaction card 200 also includes a signature block 206, issuer and network data 208, and contact information 210 such as a telephone number and physical address for the issuer of the financial transaction card 200.

The back side 202 of the financial transaction card 200 also includes a character grid 220, which is sometimes referred to as a security grid. In one embodiment, character grid 220 is in a row 222 and column 224 configuration. The illustrated embodiment includes five rows and seven columns, for a total of 35 character fields 226, but any numerical combination of rows and columns can be implemented based on the amount of space utilized on the card 200 and the font size desired for the character fields 226 within the grid 220.

In various embodiments, character grid 220 varies in shape and size, and is not necessarily below the magnetic strip 204 or on the back side 202 of the financial transaction card 200. In other embodiments, the grid 220 may be placed on a front (not shown) of the card 200. In alternative embodiments, financial transaction card 200 is one or more of a credit card, a debit card, a stored value card, a gift card, a prepaid card, and a private label card.

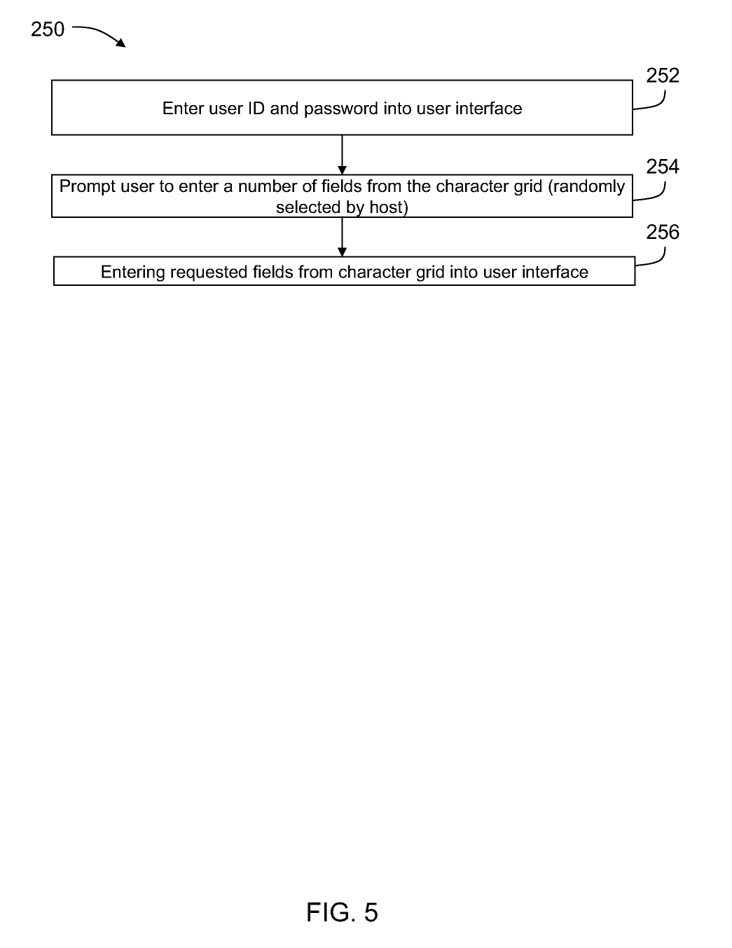

Any of the contemplated embodiments for financial transaction card 200 satisfy a model for on-line and/or website based transactions, such as retail purchases, statement checking, rewards redemption, and bill paying, that typically include two factor authentication. Referring to FIG. 5, which is a flowchart 250 of the two factor authentication model, the cardholder is allowed to login into a website, for example to make a purchase, by first entering 252 their user identification and password as a first factor in a two factor authentication. The website then prompts 254 the cardholder to enter the contents of a number of random (selected by the host) character fields 226 from the character grid 220 printed on the financial transaction card 200. By correctly entering 256 the requested character field contents into an input device (e.g., (the user interface associated with the website), the cardholder satisfies the second authentication factor. The above described approach avoids the shipping and handling of a second physical card with a grid or some other physical device to provide a second authentication factor. Of course it is easier for the legitimate cardholder to not have to maintain a second physical device to consummate, for example, on-line transactions.

The character grid 220 (shown in FIG. 4) is tied back to the cardholder when the financial transaction card 200 is issued so randomly assigned characters per grid, per card are assigned. The character grid 220 is assigned to the user's card number and, upon registering for a user identification and password, the character grid 220 is linked to the financial transaction card 200 and the cardholder at the interchange. Subsequently, when the cardholder logs in, they are asked for their user identification and password. If the user identification and password are received correctly, the user, through the user interface, is then prompted for the characters from a number of different character fields 226 in the character grid 220.

At each login, character field contents requested is randomly generated by system 100. For example, during a first login process, the user interface may prompt the user to enter the characters at character fields B1, A3, E4, G5 and C2 of the character grid 220. In this scenario, the proper response is to enter “84ZIV”. A subsequent login may request entry of the characters at character fields C5, F3, G2, C3, and A1. The proper response is to enter “5VPNT”. Of course many combination are possible, depending on the number of rows and the number of columns, and therefore the number of character fields 226, associated with the character grid 220.

The above described second authentication factor is implemented as a portion of a security model, as mentioned above, which, in addition to reducing illegitimate purchases, can also be used as part of the login process for one or more of statement viewing, online bill payment, online reward redemption, depending on the card function (i.e., if the card is a credit card, debit card, pre-paid card, etc.).

The embodiments are also effective for anonymous gift cards. Although such cards are typically treated as cash, if someone that tried to utilize such a card without knowledge of how the character grid was implemented, there is a possibility that they could not use the gift card for an online purchase or other transaction not made in person.

Flowchart 250 illustrates one exemplary process that is utilized by system 100 (shown in FIG. 2). System 100 is sometimes referred to as the financial transaction card payment system, which is accessed at some point during the above described two factor authentication process. In the example embodiment, system 100 may be utilized by an “issuer” who issues a financial transaction card, a consumer who uses the financial transaction card in the various transactions described herein, a merchant who sells a product, a “merchant bank” or an “acquiring bank”, and a credit card network or interchange for processing financial transactions of the type listed above.

In the example embodiment, system 100 facilitates a two factor authentication process which, at least in part, assesses whether the user (or a designee of the user) of the financial transaction card is in actual physical custody of the financial transaction card 200. The technical effect of the processes and systems described herein is achieved by verifying that the correct characters have been entered into a user interface by a user. As described above, the correct characters are those characters that correspond to a number of character grid locations (e.g., character fields 226) that were randomly generated utilizing system 100 and presented to the user after a correct entry of a user identification and a password.

In another embodiment, a computer and a computer program are provided which are configured or programmed to perform steps similar to those already recited herein.

The systems and processes described herein enable a user, such as a financial transaction card network (e.g., MasterCard®), to reduce the number of fraudulent transactions that take place with respect to an account of a cardholder who may have inadvertently allowed one or more of their account number, user ID, and password to be acquired by another, unauthorized, person. Once a potential user of a financial transaction card-based account has entered a correct user identification and password associated with an account, the transaction card network works to provide a second factor of authentication, by automatically generating a random list of character grid locations, the contents of which are to be entered into a user interface by the user. Should the user not be in physical possession of at least a copy of the physical financial transaction card, they generally will not be able to enter the second authentication factor implemented by the operator of the transaction card network.

The system described herein stores a character grid configuration for each of a plurality of issued financial transaction cards such that each may be utilized with the second authentication factor described in detail above, providing the end result of more secure transaction for legitimate cardholders and a more difficult transaction for someone illegitimately trying to utilize the account of the financial transaction cardholder.

While the invention has been described in terms of various specific embodiments, those skilled in the art will recognize that the invention can be practiced with modification within the spirit and scope of the claims.

What is claimed is:

1. A financial transaction card comprising a front side and a back side, said financial transaction card further comprising:
a magnetic strip configured to retain data associated with a financial transaction card account, the account associated with said card; and
a character grid printed on one of said front side and said back side.

2. A financial transaction card according to claim 1 wherein said character grid comprises a plurality of rows and a plurality of columns forming a plurality of character fields.

3. A financial transaction card according to claim 2 wherein said character fields each comprise a character printed therein.

4. A financial transaction card according to claim 3 wherein said characters are randomly generated for printing onto said financial transaction card.

5. A financial transaction card according to claim 3 wherein said characters within said character grid are associated with an account number associated with said financial transaction card.

6. A financial transaction card according to claim 1 wherein said financial transaction card comprises at least one of a credit card, a debit card, a stored value card, a gift card, a prepaid card, and a private label card.

7. A financial transaction card according to claim 1 wherein said character grid is associated with a cardholder registered with a network associated with said financial transaction card.

8. A financial transaction card according to claim 1 wherein said character grid comprises a plurality of character fields, a content for each said character field printed on said card and stored at a network associated with said financial transaction card.

9. A method for securing transactions that are not made in person, utilizing a financial transaction card and an input device, the financial transaction card including a two-dimensional character grid of character fields each having a character printed therein, said method comprising:
entering, into the input device, a user identification and password that are associated with the financial transaction card;
receiving a prompt that requests the cardholder to enter the characters associated with a number of character fields in the character grid printed on the financial transaction card; and
entering the characters printed within the requested character fields into the input device.

10. A method according to claim 9 wherein receiving a prompt comprises requesting entry of characters printed within the character grid for a plurality of row and column combinations.

11. A method according to claim 9 further comprising associating characters within the character grid with the financial transaction card and respective financial transaction card account.

12. A method according to claim 9 wherein receiving a prompt comprises receiving a prompt to enter a number of characters from the character grid that correspond to row and column locations of the character grid, the row and column locations randomly selected by a host computer.

13. A network-based system for securing financial transaction card account transactions, the transactions including those made independently by customers over a financial transaction card network, said system comprising:
a plurality of financial transaction cards each comprising a character grid of character fields printed on at least one of a front side and a back side of said card, said character fields each having an individual character printed therein;
a client system comprising a browser;
a database for storing information; and
a server system configured to be coupled to said client system and said database, said server system further configured to:
store within said database a plurality of said character grids, each character grid representative of a character grid printed on a respective one of said financial transaction cards;
upon receipt of a user identifier and password from a potential customer for a specific one of said financial transactions cards, cause said client system to prompt the potential customer to enter the characters associated with a number of specific character grid locations as printed on the specific said financial transaction card;
upon receipt of characters from said client system, compare the received characters to determine if they match the corresponding characters for the individual said financial transaction card stored within said database.

14. A system according to claim 13 wherein the prompt from said client system comprises a plurality of row and column locations within the character grid.

15. A system according to claim 13 wherein said server system is configured to randomly generate characters for printing onto said character fields of said financial transaction card.

16. A system according to claim 13 wherein said server system is configured to associate said characters within said character grid on said financial transaction card with an account number also associated with said financial transaction card.

17. A system according to claim 13 wherein said plurality of financial transaction cards comprises at least one of credit cards, debit cards, stored value cards, gift cards, prepaid cards, and private label cards.
